(19) United States
(12) Patent Application Publication
(10) Pub. No.: US 2011/0024495 A1
(43) Pub. Date: Feb. 3, 2011

(54) Machine and Process for Paperless Receipts

(76) Inventor: Gerald G. Anderson, Fresno, CA (US)

Correspondence Address: RICHARD A. RYAN;ATTORNEY AT LAW, 440 W. FALLBROOK AVENUE, SUITE 104, FRESNO, CA, 93711, US

(21) Appl. No.: 12/573,872

(22) Filed: Oct. 5, 2009

Related U.S. Application Data
(60) Provisional application No. 61/230,079, filed on Jul. 30, 2009.

(51) Int. Cl. G06F 17/00

(52) U.S. Cl. 235/380

(57) ABSTRACT

An improved transaction machine and a system and method using such machine for obtaining a paperless receipt from the transaction machine, which may be an ATM, vending machine, cash register machine or the like. The transaction machine is configured similar to standard transaction machines except it includes a USB port configured to receive a user's USB drive and/or a keypad or touch screen configured to allow the user to input his or her email address. Instead of printing the receipt, the user selects whether he or she wants the electronic transaction receipt transmitted to the USB drive through the USB port or to his or her email address via the Internet. Eliminating paper receipts will reduce costs and reduce the environmental impact of transaction machines by reducing paper and ink usage and waste. In addition, the transaction machine will improve contacts with customers by capturing email addresses for later use.

### CROSS-REFERENCE TO RELATED APPLICATIONS

This patent application claims the benefit of U.S. Provisional Patent Application No. 61/230,079 filed Jul. 30, 2009.

### STATEMENT REGARDING FEDERALLY SPONSORED RESEARCH

Not Applicable.

### BACKGROUND OF THE INVENTION

A. Field of the Invention

The field of the present invention relates generally to machines and processes for accomplishing ATM transactions and for facilitating the purchase of a product or service. In particular, the present invention relates to such machines and processes that are configured to provide a confirmation receipt from an ATM, cash register, vending machine or similar machines. Even more particularly, this invention relates to such machines and processes that allow the user to more efficiently and with less waste obtain confirmation of his or her purchase.

B. Background

Many products and services are available for purchase through an automated vending machine that allows a person to obtain the desired product or service by inserting a card into the machine, or otherwise interacting with the machine and selecting a desired product or service. Examples of automated vending machines include gasoline dispensing machines, food and/or drink vending machines, stamps and car/truck washing. Purchases are also made at cash register types of machines where the person buying the product or service either slides his or her card through a card reader or hands the card to a clerk or other employee who uses the card to register the purchase. Examples of cash register types machines include those at grocery and department stores, convenience markets, fast food or other take-out eateries, dine-in restaurants, sporting goods stores, electronic stores, spas, beauty parlors and a wide variety of other types of stores that sell products or services. Other machines, commonly referred to as ATMs, allow the user to check his or her bank balance, make deposits and/or withdraw cash. Although not exclusively, ATMs are frequently associated with a bank or banking-like institution. ATMs are also placed in malls, stores, amusement parks, casinos and other locations where people tend to spend money so they can obtain more cash when needed. For purposes of the present disclosure, the term “transaction machine” is utilized to collectively refer to automated vending machines, cash register type machines, ATMs and similarly configured machines, all of which have in common the fact that a person or someone on his or her behalf accesses the transaction machine to purchase goods and services, engage in a transaction with a bank or other financial institution or to accomplish similar transactions.

The primary benefit of transaction machines is convenience for the user and lower employee costs and quicker payment for the business utilizing the transaction machine. In fact, the benefits of transaction machines have made these a nearly irreplaceable staple of modern life. No longer does a person have to worry about whether he or she has sufficient cash on their person or have to engage an operator or other person to obtain certain goods or services (i.e., to vend gasoline from a pump, obtain cash from a bank, etc.). Another primary benefit of transaction machines has been the elimination of the need to write a check to make a purchase, which eliminates the need to transfer the check from the location where the check was presented to the bank or other financial institution that will honor or otherwise pay the check. This has saved businesses and their customers significant cost and time.

Transaction machines print and dispense a receipt that shows the items that were purchased, the payment from the purchaser's account and/or other details of the transaction. Most people expect and desire a record of the transaction so they may verify the purchase or have the receipt available if they must return or exchange the product. Most businesses require a copy of the receipt in order for their employees to obtain reimbursement for business-related expenses. In addition, the IRS and state tax agencies require receipts to verify tax-deductible costs. As such, obtaining a receipt from the transaction machine is presently considered an integral part of the use of the transaction machine by most persons who utilize such machines.

A major issue with regard to transaction machines is the cost and environmental unfriendliness of the paper receipts. As well known to those in the transaction machine business, the cost of the paper, ink and other supplies to print receipts is not an insignificant amount. In addition, printing of receipts requires more maintenance for the transaction machine. To compound the issue, although many people hold onto and use the transaction machine receipts, a significant number of people only briefly look at the receipt to verify the amounts and then discard the receipt. Those persons who desire or need to keep the receipt for reimbursement, tax or other purposes have to place the receipt in a location where it can be later retrieved. Unfortunately, it is not uncommon to lose the receipt, thereby negating the whole purpose of getting the receipt. Improperly disposed receipts create litter problems and those receipts which do end up in the trash must then be transferred to a waste processing facility or disposed of in a landfill or the like. Use of ink and paper utilizes natural resources that could be put to much better use. For instance, the many millions of transaction machines in use no doubt utilize a significant amount of paper, which results in an increase in tree harvesting and less trees available for oxygen production. As a result of the above, the printing and dispensing of the receipts from transaction machines is generally considered to be in conflict with the public's desire to have more environmentally friendly or “green” products and services.

The use of email to communicate with family, friends or other people, and with schools, business, government agencies and other institutions has become very common. In fact, most people have one or more email accounts and utilize email as a preferred, if not the preferred, manner of communicating in writing. Businesses commonly transmit account information and promotional materials to their customers and potential customers via email. Many people also utilize USB drives with their computers to store data and/or to move data from one computer to another. As well known, the USB drives are inserted into one of the computer's USB ports to electronically communicate with the computer. Data on the USB drive can be viewed on the computer screen and/or transmitted to the computer. Data on the computer can be saved on the USB drive. Some USB drives and computers are cooperatively configured such that the computer recognizes the particular USB drive and allows the user who inserted the USB drive to access areas of the computer, typically by use of one or more passwords, that are not available to others who do not have the USB drive. Likewise, some USB drives are configured to allow access to certain areas of the USB drive only when it is connected to a particular computer.

What is needed, is an improved machine and process for obtaining verification and receipts of purchases and other uses of transactional machines. Such an improved machine and process should reduce the quantity of paper produced, reduce the cost of maintaining transactional machines and still provide persons with the desired transaction verification and, for those who need it, a written receipt for reimbursement and/or tax purposes. An improved machine and process should reduce the waste of paper, reduce the likelihood of litter and be more “green” so as to reduce the negative environmental impact of transaction machines.

### SUMMARY OF THE INVENTION

The machine and process for paperless receipts of the present invention provides the benefits and solves the problems identified above. That is to say, the present invention discloses an improved transaction machine and process of utilizing such machines that significantly reduces the amount of paper produced by such machines. The transaction machine and process of the present invention allows a person utilizing such a machine to eliminate the need to obtain a printed receipt from the machine while still allowing him or her to verify the transaction and, if desired, obtain a written receipt that can be used to obtain reimbursement or to verify expenses tax purposes. The machine and process of the present invention provides a more efficient and effective way for a person to track his or her expenditures. In addition, the transaction machine and process of the present invention provides customer contact advantages to the owner and/or operator of the machine.

In a primary embodiment of the present invention, the machine for paperless receipts generally comprises a machine body, a USB port on the outer surface (which is the surface accessed by a user of the machine) and a means of transferring an electronic transaction receipt to a USB drive (or other data storage device) or email address associated with the user. As with standard transactions machines, the machine body of the present invention also has at least one of a display panel and a keypad on the outer surface of the machine body that are configured to transmit transaction information to and/or from the transaction machine. The USB port on the outer surface of the machine body is placed so as to be easily accessible to the user utilizing the transaction machine. The USB port is configured to receive the USB drive provided by the user and electronically communicate therewith so as to store the electronic transaction receipt thereon. The transmitting means is configured to transmit the electronic transaction receipt to at least one of the USB drive or an email address that is associated with the user. In one embodiment, the user enters an email address into the transactional machine utilizing at least one of the display panel and the keypad. In another embodiment, the email address is associated with the user's credit/ATM card or other small portable account access device which is read by a card reader or other appropriately configured device reader for inputting and transmitting data for the benefit of the user that is also provided on the outer surface of the body. In yet another embodiment, the email address is associated with the USB drive, such as being stored on the USB drive and then retrieved by the machine, either automatically or in a manner controlled by the user. In another embodiment of the present invention, the user's USB drive can contain information that identifies the user to allow him or her to conduct transactions with the transaction machines without the need for the credit/ATM card.

A system for paperless receipts comprises the transaction machine, USB drive and transmitting means described above and a central processing unit (“CPU”), or other device that controls and processes information for the benefit of the user, for storing information utilized by and received from the transaction machine. A method of obtaining paperless receipts generally comprises the steps of providing a transaction machine configured as above, selecting at least one of the USB drive and the email address associated with the user to receive the electronic transaction receipt and transmitting the electronic transaction receipt to at least one of the USB drive or the email address. If the receipt is to be transmitted to the USB drive, it must be inserted into the USB port prior to the transmitting step. If the receipt is to be transmitted to the user's email address, the email address must be entered by the user or be associated with the user's account, credit/ATM card and/or USB drive.

Accordingly, one of the primary aspects of the present invention is to provide a machine and process for paperless receipts that has the advantages discussed above and which overcomes the disadvantages and limitations associated with presently available transaction machines and processes for obtaining confirmation receipts from such machines.

It is an important aspect of the present invention to provide an improved transaction machine that reduces or eliminates the printing of receipts by allowing the user to selectively receive confirmation of the transaction by email and/or on a USB drive inserted into the machine.

It is also an important aspect of the present invention to provide a transaction machine that reduces the cost of operating the machine and the environmental impact of the machine by reducing or eliminating the need to print receipts that confirm a user's transaction with the machine.

It is also an important aspect of the present invention to provide a transaction machine that assists the owner or operator of the machine with identifying customers and potential customers and by facilitating communication with the existing or potential customers.

It is also an important aspect of the present invention to provide a process of utilizing a transaction machine that benefits the user by providing receipts that are easier to handle and store, benefits the owner or operator of the machine by reducing maintenance costs and by improving the identification and communication with existing and potential customers and benefits the environment by eliminating unnecessary use of paper and accumulation of trash by eliminating or substantially reducing the amount of paper receipts that are generated by the machine.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a transaction machine that is configured according to a preferred embodiment of the present invention and which utilizes the processes of the present invention to provide a non-printed receipt for the user of the machine;

FIG. 2 is a schematic view of a system utilizing the machines and processes of the present invention;

FIG. 3 is a flow chart showing a method of utilizing the transaction machine of the present invention to reduce or eliminate paper receipts; and

FIG. 4 is a schematic chart showing the various associations between the components of the machine, system and method of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the machine and process for paperless receipts, those skilled in the art will readily understand that this is merely for purposes of simplifying the present disclosure and that the present invention is not so limited.

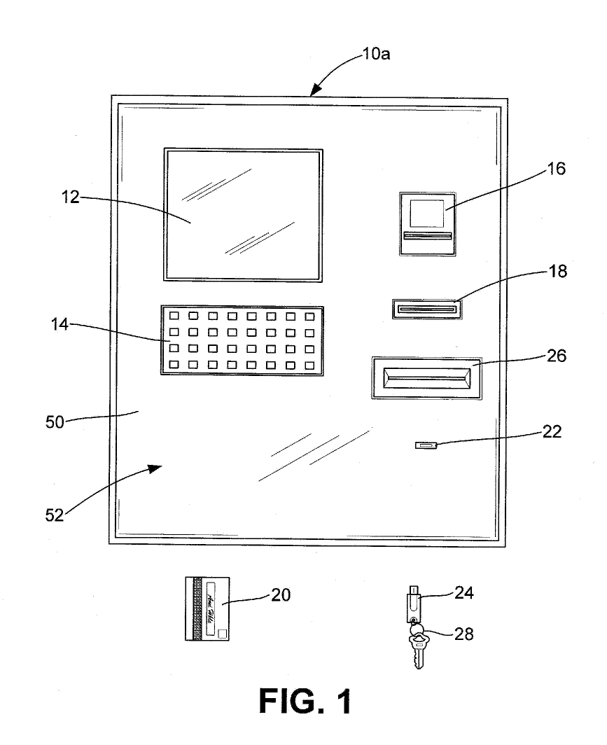

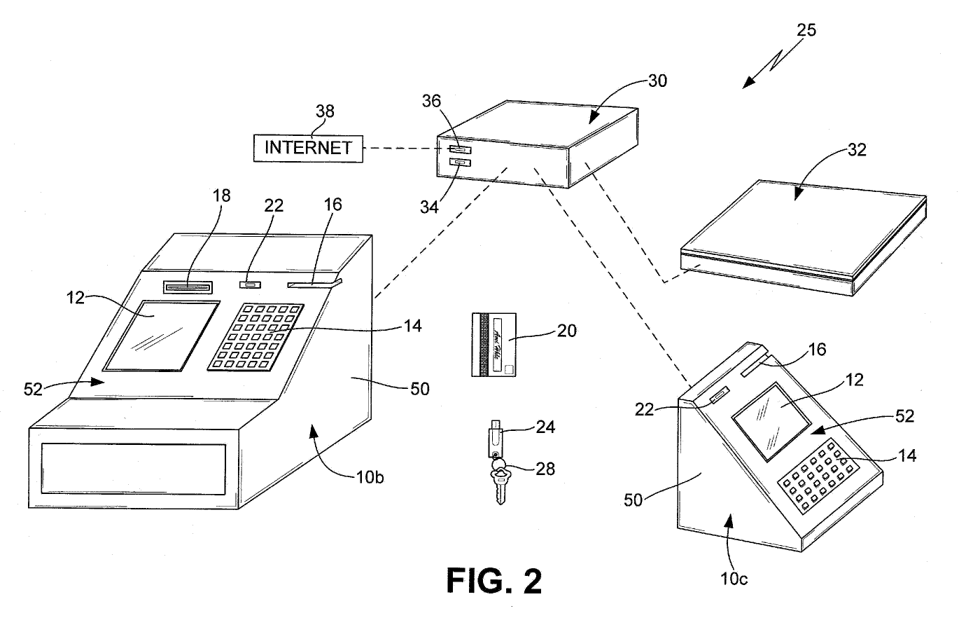

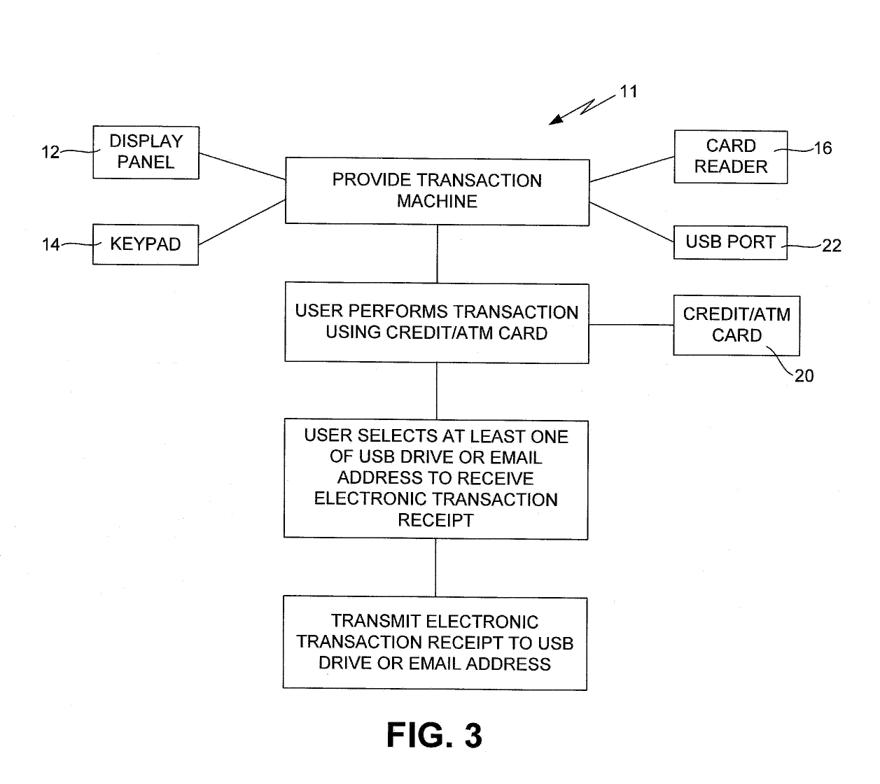

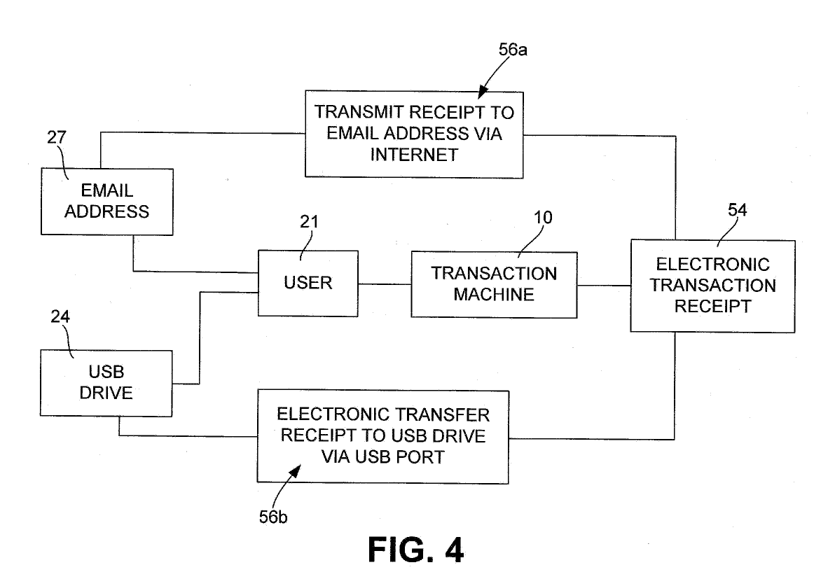

An improved transaction machine that is configured pursuant to one embodiment of the present invention is shown generally as 10 in FIGS. 1 and 2. As with presently configured transaction machines, the transaction machines 10 of the present invention can be utilized to purchase goods and/or services or to transact business with a bank or other financial institution. As shown in FIG. 1, transaction machine 10a is configured as an ATM-type machine comprising a machine body 50 having an outer surface 52 with a display panel 12, a keypad 14, a card reader 16 and a paper receipt dispenser 18 (as is typical with standard transaction machines). In FIG. 2, the transaction machines are a cash register type of transaction machine 10b and a customer input/payment machine 10c. For purposes of this disclosure, the above transaction machines and all related transaction machines are referenced collectively by the numeral 10 and, when relevant, specifically by 10a, 10b or 10c. A preferred embodiment of the method of the present invention is shown as 11 in FIG. 3. The various associations of the components and users of a preferred embodiment of the machine, system and method of the present invention is shown in FIG. 4. As will be readily apparent to those skilled in the art, the transaction machine 10 and method 11 of the present invention is not limited to the machines 10a, 10b or 10c shown or otherwise set forth in FIGS. 1 through 4. Instead, the various principles and processes of the present invention can be incorporated into a wide variety of machines which are utilized by people to transact business or accomplish other transactional type objectives.

As familiar to those who utilize transaction machines 10, typically a credit/ATM card 20 is utilized by the user 21 to access the transaction machine 10 and purchase the desired goods and/or services or to obtain cash or otherwise conduct business with a financial institution. As explained in more detail below, several of these standard features are modified for the machine 10 and method 11 of the present invention. As shown in FIGS. 1 and 2, a preferred embodiment of transaction machine 10 of the present invention has a USB port 22, that is configured to receive and operatively connect with a USB drive 24 that is associated with the particular user 21 of machine 10. The USB drive 24 is a standard data storage device that is inserted into the USB port 22 to receive and store transactional information from the transaction machine 10 for later retrieval by the user. Although the preferred embodiment utilizes USB port 22 and USB drive 24, due primarily to the availability and popularity of these devices, the present invention is not so limited. Instead of USB drive 24, the machine 10 of the present invention can be utilized with other small, portable data storage devices, which may be configured similar to USB drive 24, for receiving and storing data from machine 10 having a port or other device-receiving receptacle that is configured to transfer data between the machine 10 and the portable data storage device. Preferably, the paper receipt dispenser 18 will rarely be utilized in favor of the improvements provided by the machine 10 and method 11 of the present invention. Over time, as people become more familiar with the new transaction machine 10, it should be possible to eliminate (phase out) the paper receipt dispenser 18.

As with standard transaction machines, the transaction machine 10 of the present invention is initially accessed, at outer surface 52 of machine body 50, by the user 21 by inserting his or her card 20 into the card reader 16. The user 21 enters the required passwords or other codes by utilizing keypad 14. Information relevant to the transaction is displayed at the display panel 12. Some transaction machines 10 may combine the features of the display panel 12 and the keypad 14 by utilizing touch-screen technology. For purposes of the present invention, display panel 12 and keypad 14 may be two separate components or they may be combined into a single, integral unit. As with present transaction machines, user 21 can obtain a paper receipt from the paper receipt dispenser 18. Cash or other materials are dispensed through the cash dispenser 26. The advantage of the transaction machine 10 and process of the present invention is that the need to have a paper receipt can be eliminated by utilizing USB port 22 and drive 24 or an email address 27, shown in FIG. 4, that is associated with the user 21 to obtain the desired transaction information, which is in the form of an electronic transaction receipt 54.

As will be readily understandable to those familiar with USB ports and drives, the user 21 of transaction machine 10 inserts his or her USB drive 24 into the USB port 22 to establish a connection between the USB drive 24 and the transaction machine 10. With the connection established, electronic transaction receipt 54 can be transferred to the USB drive 24 for storage thereon instead of to the paper receipt dispenser 18, thereby eliminating the paper receipt and the waste of ink and paper associated therewith. In one embodiment, the USB drive 24 can be small so the user 21 can easily carry it with him or her (i.e., using an attached key chain ring 28 or other carrying means) for use with transaction machine 10. The user 21 can later review the receipt information stored on the USB drive 24 on his or her computer and, if desired, download it to a computer file for electronic filing or print a receipt for reimbursement or expense verification purposes. As such, the user 21 will be able to better track and retain the receipt because he or she will be at the home or office where it is easier and, therefore, more likely to be properly filed or otherwise handled. The display panel 12 and/or keypad 14 can be modified to include the option to send the receipt information to the user's USB drive 24. In addition, the display panel 12 can display the receipt information, which for many people and/or transactions is the only receipt information that is needed or desired.

In addition or alternatively to the USB drive 24, the paper receipt can be eliminated by utilizing an email to send the electronic transaction receipt 54, typically via the Internet 38, to the user's email address 27 for later access at his or her computer. In this embodiment, the display panel 12 and/or keypad 14 is modified to provide alphanumeric keys so the user 21 can enter in his or her email address 27 and to provide the option to the user 21 to send the receipt information to his email account. If the user 21 selects this option, the electronic transaction receipt 54 is emailed to the email address 27 entered by the user 21. Alternatively, or in addition thereto, the email address 27 of user 21 can be associated with his or her bank or other account (i.e., gasoline or store account) so the user 21 does not have to enter the email address 27 each time he or she makes a transaction at the transaction machine 10. In another embodiment, the user's email address 27 can be associated with (e.g., electronically or embedded on) his or her credit/ATM card 20 so the user does not have to enter the email address 27. Instead of a credit/ATM card 20, the machine 10 of the present invention can be configured for use with other small, portable account access devices and have an appropriately configured reader for exchanging information between the device and machine 10. In yet another embodiment, the email address 27 can be associated with a user's USB drive 24. In one configuration of this embodiment, USB drive 24 can have a file or other identifying means thereon for associating the user's USB drive 24 with his or her account(s) that allows the transaction machine 10 to retrieve, automatically or by user authorization, the user's email address 27 from USB drive 24. In the above embodiments, the user only has to select the email receipt option displayed on display panel 12 and the electronic transaction receipt 54 will be automatically sent to his or her email address 27. As with the USB drive storage option, the electronic transaction receipt 54 can then be reviewed on the user's home/business computer and, if desired, downloaded to a computer file for electronic filing, emailed to a corporate or other office or printed if a written record is needed for reimbursement or expense verification purposes.

The transaction machine 10 of the present invention will include a means 56 for transmitting the electronic transaction receipt 54 to at least one of the user's email address 27 or the user's USB drive 24. In one embodiment, the transmitting means, shown as 56a in FIG. 4, is the Internet 38. As shown, the electronic transaction receipt 54 is transmitted to the user's email address 27 via the Internet 38, or by other appropriate online data transfer system, utilizing the appropriate electron medium and software, both of which are well known in the art. If the user 21 selects the USB drive 24, instead of or in addition to the email address 27, the electronic transaction receipt 54 is transferred to the USB drive 24 via the USB port 22 utilizing internal electronic transfer processes that are also well known in the art.

A typical system 25 using the transaction machines 10 of the present invention is illustrated in FIG. 2. In the system shown, the transaction machines are a cash register machine 10b and a customer input/payment machine 10c. As shown, these two machines 10b and 10c are connected to a central or host CPU 30 that provides computer capabilities for the system. The transaction machines 10, which can include other types of machines, are connected to the CPU 30 using conventional and readily available, whether presently or in the future, wired or wireless connection means. The CPU 30 is utilized for on-site storage of the transaction data and for storage of user information, such as his or her email address 27 and other contact and/or purchase information. As set forth in more detail below, the user's email address 27 can be utilized for mass or single email solicitations and notices of special events and promotions. Also connected to CPU 30 is a data input device, such as a scanner 32, for use to send camera ready flyers to add sparkle or otherwise jazz-up the company's solicitation. As with transaction machine 10, the scanner 32 or other device may be wired or wirelessly connected to the CPU 30. Preferably, the CPU 30 has a input connector 34 that allows the owner or user of transaction machine 10 to connect a second computer, such as a laptop computer, desktop computer or the like, to the CPU 30 so he or she can access the data on the CPU 30 as necessary or desired. The CPU 30 should include an Internet connection port 36 that allows the owner/operator to connect, via a wired or wireless connection, to the Internet 38. This will allow the owner/operator to send email receipts and promotions to users 21, using email data collected by the transaction machines 10 and from other sources, and access various other Internet-related services. In addition, by utilizing appropriately configured software, the owner/operator can remotely access the CPU 30 to perform various functions related thereto.

In addition to the advantages to the user of the transaction machine 10 and process of the present invention, there are also advantages to businesses that own, operate or which are accessed by the transaction machine 10. One advantage is that the business will be able to promote the fact they are going “green” and their commitment to being environmentally friendly. Another, perhaps more important advantage, is that the business using the transaction machine 10 will be able to utilize the user's email address 27 or other information associated with user 21 to promote the business's products and or services to the user 21. The transaction machine 10 can be configured to collect the email addresses 27 of users 21 that use the machine 10 and transmit that information to the bank or other business (i.e., gasoline or other company which is utilizing the transaction machine 10). The business then can use the email address 27 to send promotional offers, such as coupons and the like, or other information, such as notice of special sales or the like, to the user 21 to encourage him or her to purchase the business's products and/or services. As such, the transaction machine 10 and process 11 of the present invention will improve contact with the business's customers or potential customers and, likely, increase the business's sales and, hopefully, profits.

In use, the user 21 will generally utilize the transaction machine 10 in much the same way he or she uses presently configured transaction machines. Instead of having to receive a paper receipt through the paper receipt dispenser 16, however, user 21 can receive an electronic transaction receipt 54 information that verifies the transactions in one or more ways, such as: (1) visually on the display panel 12; (2) stored on his or her USB drive 24 through the USB port 22; or (3) via his or her email address. This will reduce the waste of ink and paper presently associated with the receipt printed from the paper receipt dispenser 16 and provide the user 21 with a more effective receipt for reimbursement or other expense verification purposes. The business using the transaction machine 10 and process of the present invention can promote going “green” and utilize the transaction machine 10 to collect email addresses 27 of users 21 of transaction machine 10 so they can promote their products and/or services to these users 21, which will benefit both the businesses and users 21.

Various modifications can be made to the transaction machine 10 and process of the present invention. For instance, the machine 10 can be configured for wireless transmission to the USB drive 24 or a different type of data storage device, such as a hand-held computing device, laptop or telephone for later review and/or printing. In another modification, the USB drive 24 can be configured such that it is utilized in the same manner as a credit/ATM card 20, which would eliminate the need to carry the a credit/ATM card 20. Instead of inserting or sliding the credit/ATM card 20 through the card reader 16, the user 21 would merely insert the USB drive 24 into the USB port 22. The transaction machine 10 would “read” or otherwise acknowledge the USB drive 24 and then require the user 21 to enter in his or her password, in much the same way as presently done with credit/ATM cards 20. After the correct password is entered, the user can accomplish the desired transaction and then store the transaction receipt information on the USB drive 24 and/or have the information sent to his or her email address 27 which, as set forth above, can be associated with his or her account, entered by the user 21 at display panel 12 and/or keypad 14, or read from the USB drive 24.

In another embodiment, the USB drive 24 or other data storage device (such as an “e-card” or the like) can be utilized as a universal charge, identification and storage device. For instance, the user's driver's license can be stored on the USB drive 24, preferably by going to the appropriate state agency or its website, and having the appropriate information placed on the USB drive 24. The user's credit card, debit card and other charge card information can also be stored on the USB drive 24 by the financial institution, via in person or through their website. To further improve functionality and convenience for the user, his or her health or gym club, private or business association, casino membership and/or other information can be placed on the USB drive 24. To ensure security for the user's information, personal identification and alphanumeric characters can be embedded on the USB drive 24 or other e-card. To further improve security, the USB drive 24 can contain a photograph of the user so his or her identity could be verified by the business or other organization accepting use of the USB drive 24. When the card is inserted into machine 10, a user screen could appear on the display panel 12 to allow the user to select the desired credit, debit or charge card which to complete the desired transaction (after the user's identification and password are verified). The transaction information is then stored on the USB drive 24 for later storage, printing or other use at the user's home and/or business location. When the transaction information is downloaded or printed, the user can remove if from the USB drive 24 to make room for additional information. All original credit, debit or other cards can be stored at a safe location desired by the user. Back-up data on the USB drive 24 can be stored on any computer. To assist with retrieval of a lost USB drive 24, it can contain information regarding the user and a reward or other enticement notice to encourage the finder to return the USB drive 24 to the user. Any such notice could be displayed when the USB drive 24 is inserted into the USB port 22, at the time the secret identification and password are required to be entered. A major advantage of the utilizing a single USB drive 24 with all of the user's credit, debit or other card information is that it would eliminate the need to carry large, bulky and generally unmanageable wallets that have to contain all the cards the user may want to use. Instead, the user can carry a single money clip or like object.

In another embodiment of the present invention, the user's card and other data can be placed on a very small microchip or other small portable storage device which is implanted in the human body. As with the USB drive 24 described above, the microchip will be configured to store data thereon and then exchange the data with a machine 10 that has a reading device that is capable of accessing the microchip by swiping, scanning or otherwise reading it with a fixed, wired, infrared or like device. As with the above, the machine 10 will display information on the display panel 12 so the user can select which card will be utilized for the transaction. The microchip will have the user's identification and password to protect use of the information thereon. The information could include the user's driver's license, health insurance, club and other information. The use of the microchip would replace all of the user's cards, thereby eliminating problems that presently arise from loss of a wallet or purse having such cards. With the use of the implanted microchip, the user will not have to worry about losing his or her valuable information, whether by misplacing it or as a result of theft. In addition, the use of the microchip eliminates the need for the bulky wallet that most people presently carry.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A transaction machine for paperless receipts, said transaction machine comprising:
a machine body having at least one of a display panel and a keypad on an outer surface of said machine body and configured to transmit transaction information to and/or from said transaction machine;
a USB port on said outer surface of said machine body accessible to a user utilizing said transaction machine, said USB port configured to electronically communicate with a USB drive provided by the user; and
means for transmitting an electronic transaction receipt to at least one of said USB drive or an email address.

2. The transaction machine of claim 1, wherein said email address is entered into said transactional machine utilizing at least one of said display panel and said keypad.

3. The transaction machine of claim 1, wherein said email address is associated with a credit/ATM card read by a card reader on said outer surface of said body.

4. The transaction machine of claim 1, wherein said email address is associated with said USB drive.

5. The transaction machine of claim 4, wherein said email address is stored on said USB drive and associated with the user.

6. The transaction machine of claim 1, wherein said USB drive contains information identifying the user of said transaction machine to allow the user to conduct transactions with said transaction machines.

7. The transaction machine of claim 6, wherein said USB drive further contains information pertaining to the user's credit cards, debit cards, membership cards and the like.

8. A system for paperless receipts, said system comprising:
a transaction machine having a machine body with at least one of a display panel and a keypad on an outer surface of said machine body and configured to transmit transaction information to and/or from said transaction machine;
a USB drive provided by a user utilizing said transaction machine, said USB drive configured to be received in a USB port on said outer surface of said machine body and accessible to the user while utilizing said transaction machine, said USB port configured to electronically communicate with said USB drive;
a CPU for storing information utilized by and received from said transaction machine; and
means for transmitting an electronic transaction receipt to at least one of said USB drive or an email address.

9. The system of claim 8, wherein said email address is entered into said transactional machine utilizing at least one of said display panel and said keypad.

10. The system of claim 8, wherein said email address is associated with a credit/ATM card read by a card reader on said outer surface of said body.

11. The system of claim 8, wherein said email address is associated with said USB drive.

12. The system of claim 11, wherein said email address is stored on said USB drive and associated with the user.

13. The system of claim 8, wherein said USB drive contains information identifying the user of said transaction machine to allow the user to conduct transactions with said transaction machines.

14. A method of obtaining paperless receipts, said method comprising the steps of:
a) providing a transaction machine having a machine body with at least one of a display panel and a keypad on an outer surface of said machine body and configured to transmit transaction information to and/or from said transaction machine, said transaction machine further comprising a USB port on said outer surface of said machine body and accessible to a user while utilizing said transaction machine, said USB port configured to receive a USB drive provided by the user utilizing said transaction and electronically communicate therewith;
b) selecting at least one of said USB drive and an email address associated with said user to receive an electronic transaction receipt; and
c) transmitting said electronic transaction receipt to at least one of said USB drive or said email address.

15. The method of claim 14 further comprising the step of inserting said USB drive into said USB port prior to said transmitting step.

16. The method of claim 14 further comprising the step of entering said email address into said transactional machine utilizing at least one of said display panel and said keypad prior to said transmitting step.

17. The method of claim 14, wherein said email address is associated with a credit/ATM card read by a card reader on said outer surface of said body.

18. The method of claim 14, wherein said email address is associated with said USB drive.

19. The method of claim 18, wherein said email address is stored on said USB drive and associated with the user.

20. The method of claim 14, wherein said USB drive contains information identifying the user of said transaction machine to allow the user to conduct transactions with said transaction machines.
